(19) United States
(12) Patent Application Publication
(10) Pub. No.: US 2009/0249018 A1
(43) Pub. Date: Oct. 1, 2009

(54) Storage management method, storage management program, storage management apparatus, and storage management system

(75) Inventors: Hiroshi Nojima, Fujisawa (JP); Nobuo Beniyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Ltd.

(21) Appl. No.: 12/124,449

(22) Filed: May 21, 2008

(30) Foreign Application Priority Data
Mar. 28, 2008 (JP) 2008-086146

(51) Int. Cl. G06F 12/02

(52) U.S. Cl. 711/170; 711/E12.002

(57) ABSTRACT

A storage management method for allocating a dynamic allocation pool so as to avoid throughput reduction. An operation management server determines the dynamic allocation pool managing allocation of a real volume in a storage device to a virtual volume. The operation management server acquires an I/O characteristic of an application being executed in a business server, records I/O characteristic information indicative of a linkage between the application and the I/O characteristic of the application for the each application in an application management table, creates an application group on the basis of the I/O characteristics of the application management table for the each application, and links the created application group to the dynamic allocation pool.

### INCORPORATION BY REFERENCE

The present application claims priority from Japanese application JP2008-086146 filed on Mar. 28, 2008, the content of which is hereby incorporated by reference into this application.

### BACKGROUND OF THE INVENTION

The present invention relates to a technique for a storage management method, a storage management program, a storage management apparatus and a storage management system.

As electronic trading or commerce is spread or multimedia data is increasingly used, the amount of data handled in companies, corporations, firms and so on is being abruptly increased. For this reason, a technique of centralizedly controlling storage devices, for example, in a typical storage area network (SAN) which can effectively handle a large amount of data is being spread. The capacity of data tends to rapidly increase. Thus, for the purpose of effectively making the most of a storage area and reducing a storage operational cost, there has been increased such a need of storage virtualization based on a virtual volume mechanism for previously provisioning a virtual volume of a large size to a business server from a storage apparatus and dynamically allocating a storage area in a real volume firstly when a request is issued from the business server to write data. It is common practice in the virtual volume mechanism that, when the virtual volume is dynamically allocated, a group of real volumes to be actually allocated are previously stored generally in a dynamic allocation storage pool (which will be referred to as the dynamic allocation pool, hereinafter).

A general technique for pooling storage devices is present not as a technique specific to the virtual volume mechanism but as a technique for collecting and managing volumes not allocated yet even in a prior art volume allocation technique. A prior art general method of operating a storage pool (which will be abbreviated merely to “pool” hereinafter) is to form a pool from the viewpoint of storage characteristics as disclosed, for example, in JP-A-2004-334561 (Pub. No. US2004/0225662). In this case, the system administrator operates the storage according to roughly two procedures which follow.

In the first procedure, the system administrator conducts pool definition. The system administrator classifies possessed storages according to the volume types, defines pools according to the classifications, and previously stores all volumes in the pools, using a storage operation management system. As a result, a group of pools of the volume types including, for example, a high-end oriented pool and an archive oriented pool are defined and used as operation management information about a storage operation management software program. This procedure is often collectively conducted as previous settings involved by the introduction of a storage device.

In the second procedure, the system administrator performs volume allocation to the business server. A storage administrator determines whether or not which pool volume is allocated to the business server on the basis of information about application performance expected values (IOPS: Input/Output per Second), and information (storage requirements) about the amount of transmission data per unit time, response time, etc.), reliability, cost and so on. Next, the administrator selects a volume of a capacity required by the application program from the pools and allocates it to the application program, using a storage operation management system. The administrator determines the allocation target volume from the configuration of the storage device, taking the fact that an access to the selected volume affects the performances of the other volumes into consideration. This procedure is often carried out as a routine operation procedure after the introduction of the storage device.

When a pool is determined in the second procedure, there may also be used a technique for determining the type of a volume as an allocation target by taking note of a characteristic of whether an access pattern of the application program on the host is a sequential orientation or a random orientation, as disclosed, for example, in JP-A-2004-13547 (Pub. No. US2003/0229698).

### SUMMARY OF THE INVENTION

The aforementioned technique, when applied to the management of the dynamic allocation pool of the virtual volume mechanism for dynamically allocating a storage area, fails to pay attention to the fact that an access from the application program having I/O (Input/Output) characteristics (access pattern and more concretely, read/write ratio, random/sequential ratio, etc.) different depending on the virtualized layer of the dynamically-allocated pool, is made finally to an identical physical disk. As a result, the aforementioned technique has a problem that access contention to the physical disk ends in the fact that the storage device cannot exhibit a sufficient throughput.

Such a problem is caused by throughput reduction specific to the physical disk. For example, when a random access takes place in the middle of a sequential access, a head seek to the disk occurs and the amount of data per unit time in the sequential access is reduced. Or when the sequential access takes place in the middle of the random access, the sequential access occupies the disk head for a long time and a wait time occurs in the random access, with the result that a response time becomes bad.

In view of such a background, it is therefore an object of the present invention to allocate a dynamic pool in such a manner as not to reduce a throughput.

In accordance with an aspect of the present invention, the above object is attained by acquiring I/O characteristics of an application program being executed by an application execution device, storing the application program and I/O characteristic information associated with the I/O characteristics of the application program in a storage for the each application program, classifying the application program into groups, and linking the classified group to the dynamic allocation pool.

In accordance with the present invention, a dynamic allocation pool can be allocated so as not to reduce a throughput.

Other objects, features and advantages of the invention will become apparent from the following description of the embodiments of the invention taken in conjunction with the accompanying drawings.

### BRIEF DESCRIPTION OF THE DRAWINGS

FIG. 1 shows a block diagram of an exemplary arrangement of a storage operation management system in accordance with the present embodiment;

FIG. 2 shows a block diagram of an exemplary structure of an operation management server in the present embodiment;

FIG. 3 shows a block diagram of an exemplary structure of a business server in the present embodiment;

FIG. 4 shows a block diagram of an exemplary structure of a storage device in the present embodiment;

FIG. 5 schematically shows processing operations in the present embodiment;

FIG. 6 shows an exemplary structure of an application management table stored in the operation management server;

FIG. 7 shows an exemplary structure of a dynamic allocation pool management table stored in the operation management server;

FIG. 8 shows an exemplary structure of a real volume management table stored in the operation management server;

FIG. 9 shows an exemplary structure of a virtual volume management table stored in the operation management server;

FIG. 10 shows an exemplary structure of an application group reconfiguration management table stored in the operation management server;

FIG. 11 shows an exemplary structure of an application I/O characteristic table stored in the business server;

FIG. 12 shows an exemplary structure of an application throughput table stored in the business server;

FIG. 13 shows an exemplary structure of requirement-index-added application management table stored in the operation management server;

FIG. 14 is a flow chart showing a flow of operations of shifting to a dynamic allocation pool environment of an existing application program in the present embodiment;

FIG. 15 is a flow chart showing a flow of operations of adding a new application program to the dynamic allocation pool environment in operation in the present embodiment;

FIG. 16 is a flow chart showing a flow of operations of reconfiguring an application group based on a change in an I/O characteristic in the present embodiment; and

FIG. 17 is a flow chart showing a flow of operations of the application group based on a requirement index in the present embodiment.

### DESCRIPTION OF THE EMBODIMENTS

Explanation will be made in detail as to the best mode (referred to as “embodiment” hereinafter) of embodying the present invention by referring to the attached drawings.

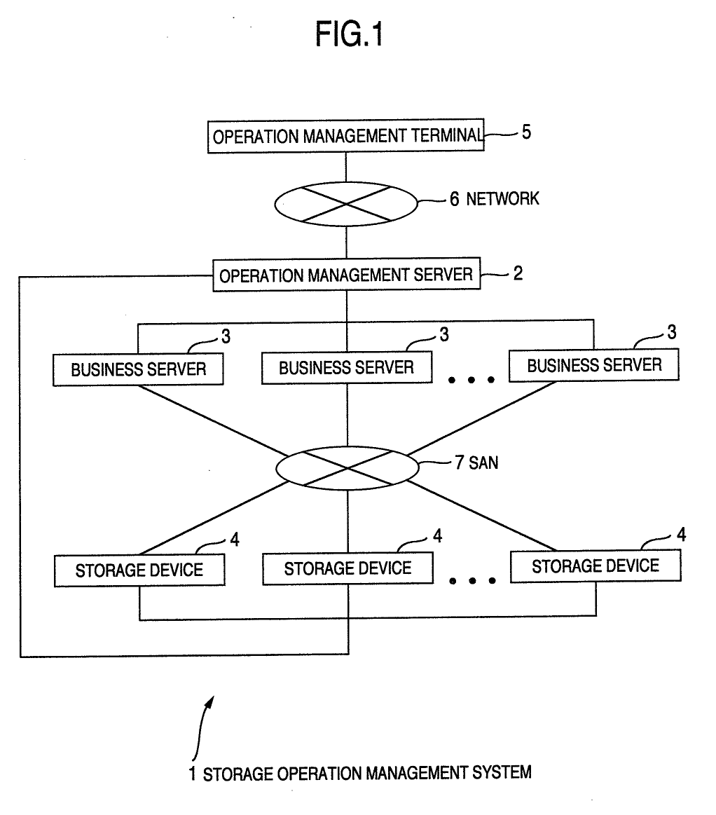

FIG. 1 shows a block diagram of an exemplary arrangement of a storage operation management system 1 in accordance with the present embodiment.

The storage operation management system 1 has an operation management server 2 (storage management device), a plurality of business servers 3 (application execution devices), a plurality of storage devices 4, and an operation management terminal 5.

The operation management server 2 and the operation management terminal 5 are interconnected by such a network 6 as a LAN (Local Area Network). The operation management server 2 and the business servers 3 are interconnected by an in-house LAN or the like. The business servers 3 and the storage devices 4 are interconnected by a storage area network (SAN) 7.

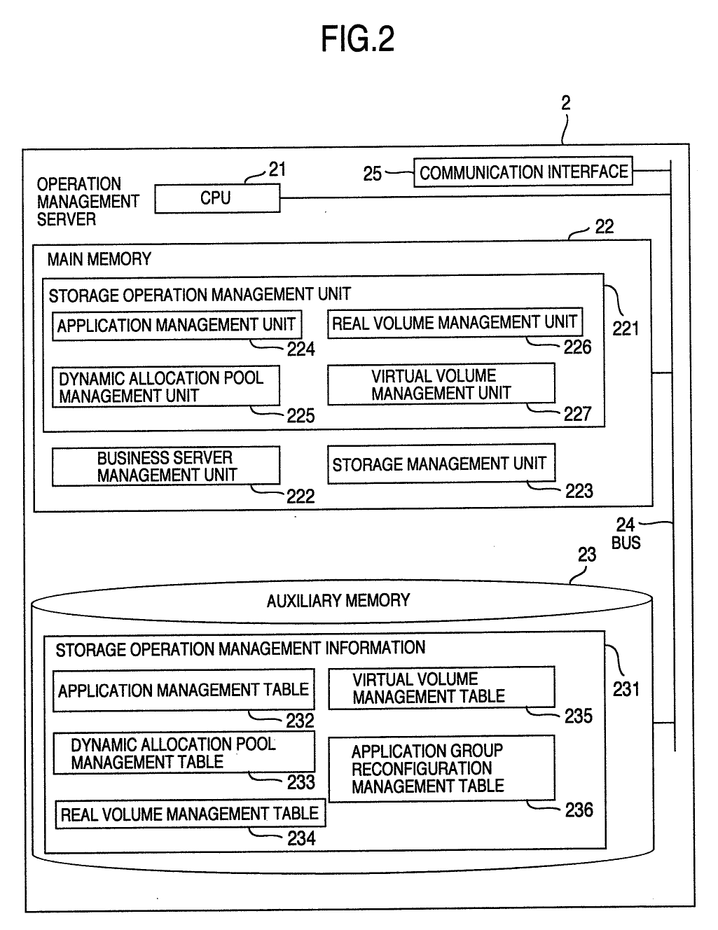

The schematic structures of the operation management server 2, the business server 3, and the storage device 4 will be explained later with reference to FIGS. 2 to 4 respectively. The operation management terminal 5 is provided, for example, as a personal computer having a display unit, an input/output unit, a storage unit, and so on (not illustrated). The operation management terminal 5 has functions of displaying the condition of the system on the display unit, inputting various instructions from a system administrator for the operation management of the storage devices, and monitoring them.

### (Operation Management Server)

FIG. 2 shows a block diagram of an exemplary structure of the operation management server 2 in the present embodiment.

The operation management server 2 has a CPU (Central Processing Unit) 21 as a processing unit, a main memory 22, an auxiliary memory 23 such as a hard disk device, and a communication interface 25 for communication with other devices via the network 6 (see FIG. 1) or a LAN. The CPU 21, the main memory 22, the auxiliary memory 23, and the communication interface 25 are interconnected by a bus 24.

When a storage operation management program stored in the auxiliary memory 23 is loaded to the main memory 22 and executed by the CPU 21, the main memory 22 stores software for implementing a storage operation management unit 221, a business server management unit 222, and a storage management unit 223 as application software. The storage operation management unit 221 has an application management unit 224, a dynamic allocation pool management unit 225, a real volume management unit 226, and a virtual volume management unit 227.

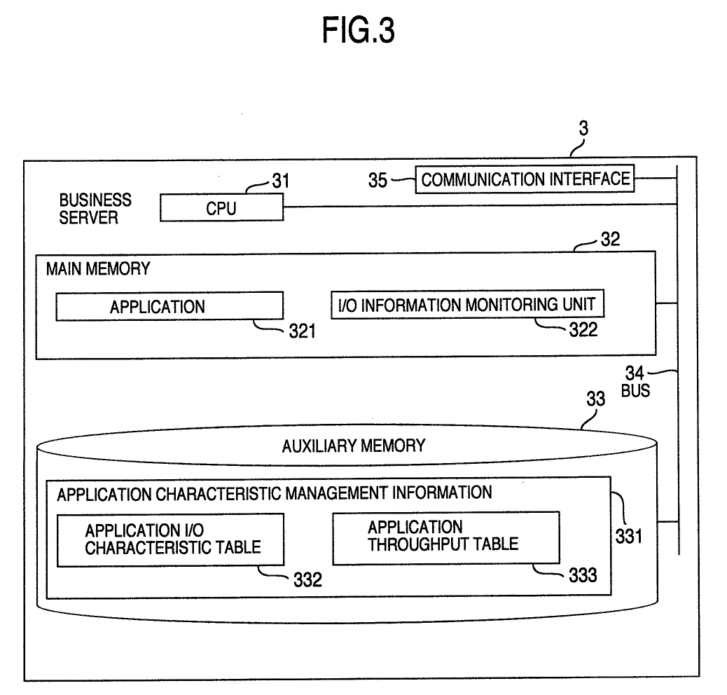

The application management unit 224 has a function of managing I/O characteristics and requirement indexes specific to an application 321 (see FIG. 3) being executed in the business server 3, and also a function of grouping the application 321 on the basis of the I/O characteristic.

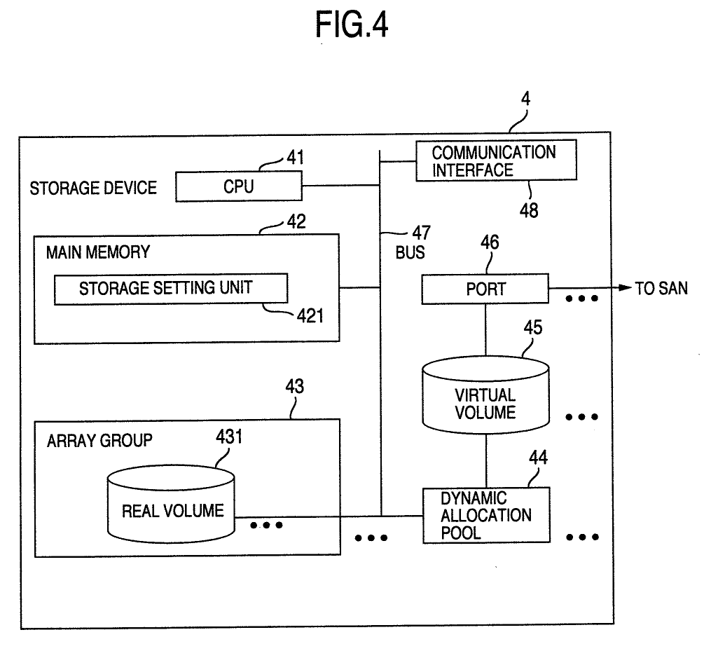

The dynamic allocation pool management unit 225 has a function of linking the application group to a dynamic allocation pool 44 (to be explained later in FIG. 4) of the storage device 4, a function of calculating an initial capacity of the dynamic allocation pool 44 on the basis of the I/O characteristic of the application 321, and also a function of linking a real volume 431 to the dynamic allocation pool 44.

The real volume management unit 226 has a function of managing the allocation state of the real volume 431 to the dynamic allocation pool 44 in the storage device 4 (to be explained later).

The virtual volume management unit 227 has a function of creating a virtual volume 45 from the dynamic allocation pool 44, and also a function of linking the virtual volume 45 to the application 321.

The business server management unit 222 (I/O characteristic acquiring unit) has a function of causing the application management unit 224 to acquire application characteristic management information 331 (see FIG. 3) from an I/O information monitoring unit 322 (to be explained later) of the business server 3 in FIG. 3.

The storage management unit 223 has a function of instructing the dynamic allocation pool management unit 225, the real volume management unit 226, and the virtual volume management unit 227 to perform storage setting operations over a storage setting unit 421 of the storage device 4 (to be explained later) in FIG. 4.

The auxiliary memory 23 stores therein an application management table 232 (I/O characteristic table), a dynamic allocation pool management table 233 (information having the application group and the dynamic allocation pool linked to each other), a real volume management table 234, a virtual volume management table 235, and an application group reconfiguration management table 236, as storage operation management information 231. The structures of these tables 232 to 236 will be explained later by referring to FIGS. 6 to 10.

### (Business Server)

FIG. 3 shows a block diagram of an exemplary structure of the business server 3 in the present embodiment.

The business server 3 has a CPU 31 as a processing unit, a main memory 32, such an auxiliary memory 33 as a hard disk device, and a communication interface 35 for communication with other devices via the network 6 (see FIG. 1) or via a LAN. The CPU 31, the main memory 32, the auxiliary memory 33, and the communication interface 35 are interconnected by a bus 34.

When a storage operation management program stored in the auxiliary memory 33 is loaded to the main memory 32 and executed under control of the CPU 31, the auxiliary memory 33 stores software for implementing an application 321 as application software to be used in the storage device 4 and the I/O information monitoring unit 322.

The I/O information monitoring unit 322 has a function of monitoring the input/output state of the application 321 and storing the input/output state as the application characteristic management information 331 in the auxiliary memory 33, and also a function of providing the application characteristic management information 331 to the application management unit 224 (refer to FIG. 2) of the operation management server 2.

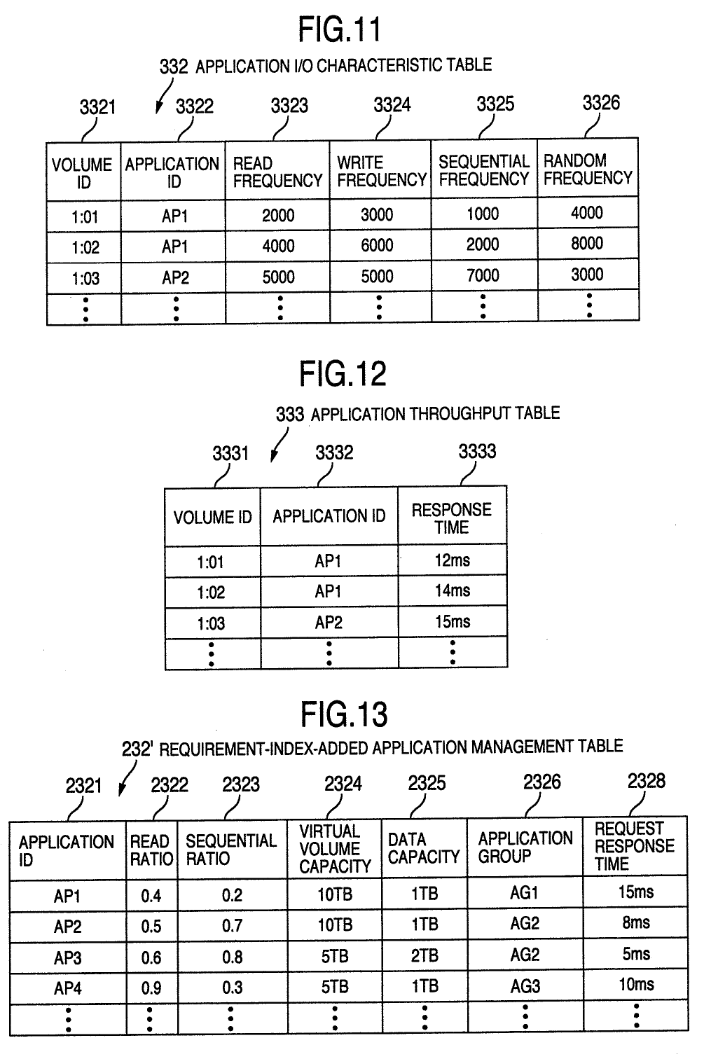

The auxiliary memory 33 stores an application I/O characteristic table 332 and an application throughput table 333 as the application characteristic management information 331. The structures of the application I/O characteristic table 332 and the application throughput table 333 will be explained later by referring to FIGS. 11 and 12 respectively.

### (Storage Device)

FIG. 4 shows an exemplary structure of the storage device in the present embodiment.

The storage device 4 has a CPU 41 as a processing unit, a main memory 42, and a communication interface 48 for communication with other devices via the network 6 (see FIG. 1) or via a LAN. The storage device 4 also has at least one port 46 for connecting the storage device 4 and the SAN 7, at least one virtual volume 45 used to store data from the business server 3 via the port 46, at least one dynamic allocation pool 44 for supplying a data storage area to the virtual volume 45 as a storage pool to the virtual volume 45, and at least one array group 43 for supplying a data storage area to the dynamic allocation pool 44. The CPU 41, the main memory 42, the communication interface 48, the array group 43, and the dynamic allocation pool 44 are interconnected by a bus 47. The port 46, the virtual volume 45, and the dynamic allocation pool 44 are interconnected by connection lines.

When a storage operation management program stored in the real volume 431 within the array group is loaded to the main memory 42 and executed under control of the CPU 41, the main memory 42 stores software for implementing the storage setting unit 421 as application software.

The storage setting unit 421 has a function of linking the dynamic allocation pool 44 to the real volume 431, a function of creating the virtual volume 45 from the dynamic allocation pool 44, and a function of enabling the virtual volume 45 to make access from the application 321 via the port 46.

The array group 43 includes at least one physical disk, having at least one real volume 431 as a unit of supplying a data storage area to the dynamic allocation pool 44.

### (Schematic Processing Operation)

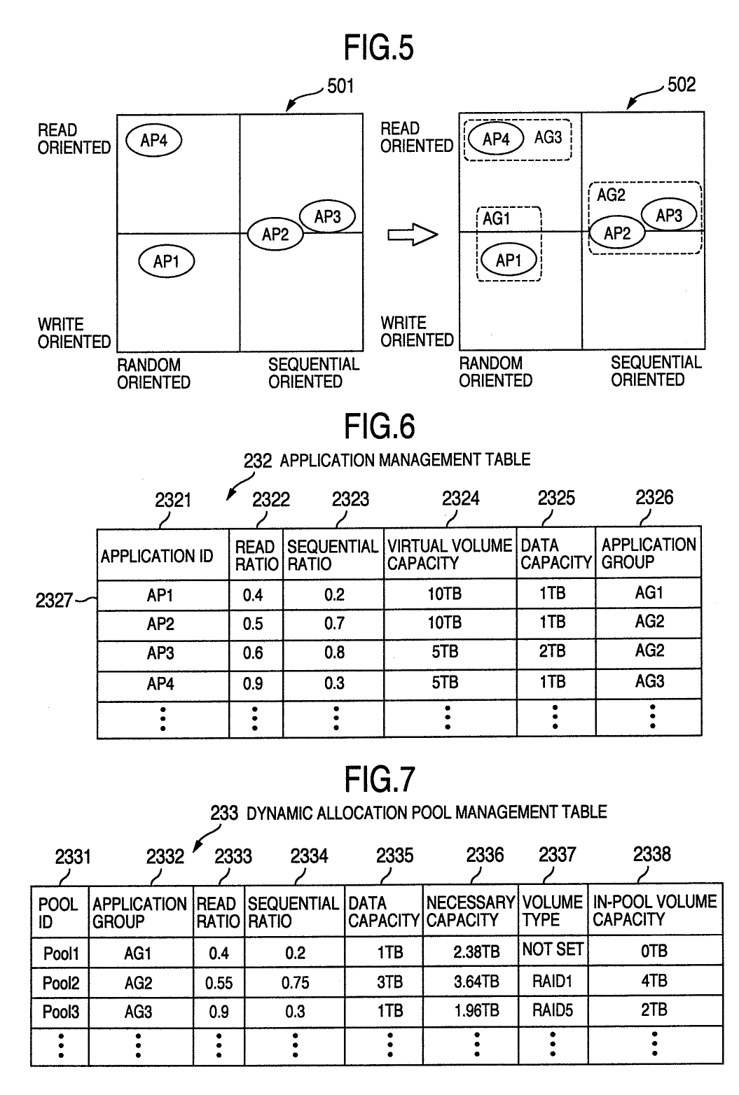

FIG. 5 schematically shows the processing operation of the present embodiment.

FIG. 5 shows, as an example, a conceptual view of grouping the applications 321 having similar I/O characteristics on the basis of the I/O characteristics (read/write ratio and random/sequential ratio) of the applications 321.

Graphs 501 and 502 in FIG. 5 show I/O characteristics of the applications 321. In the drawing, ordinate denotes read/write ratio and abscissa denotes random/sequential ratio. AP1 to AP4 denote the applications 321 respectively.

In the ordinates of the graphs 501 and 502, as the application goes upwards, the application is oriented more to read; whereas as the application goes downwards, the application is oriented more to write. The applications 321 located at the midpoint of the ordinate have nearly the same read and write ratios.

Similarly, in the abscissas of the graphs 501 and 502, as the application 321 goes rightwards the application is oriented more to sequential; whereas as the application 321 goes leftwards, the application is oriented more to the random. The applications 321 located at the midpoint of the abscissa have nearly the same sequential and random ratios.

It will be seen from the graph 501 that applications AP2 and AP3 have similar I/O characteristics and that there is no application that is similar in I/O characteristics to application AP1 or AP4. Accordingly, as shown in the graph 502, the applications AP2 and AP3 are grouped into the same application group AG2; and the applications AP1 and AP4 are grouped into different application groups AG1 and AG3 respectively.

The present embodiment determines the dynamic allocation pool 44 in the storage device 4 on the basis of such application groups.

### (Application Management Table)

By referring to FIGS. 6 to 13, explanation will then be made as to the structures of tables used in the present embodiment.

FIG. 6 shows an exemplary structure of the application management table 232 stored in the operation management server. The application management table 232 is used to manage information about the applications 321 to be operated on the business servers 3.

The application management table 232 has an application ID column 2321, a read ratio column 2322, a sequential ratio column 2323, a virtual volume capacity column 2324, a data capacity column 2325, and an application group column 2326, respectively including the corresponding fields.

An application ID in the column 2321 denotes information as the identifier of the application 321, and used as a primary key in the application management table 232. When I/O of the storage device 4 in the application 321 (which will be referred to as the target application 321, hereinafter) having the application ID is classified into read and write; a read ratio in the column 2322 indicates a proportion occupied by read. In a row 2327, a read ratio is 0.4, meaning that 40% of all I/O in the application AP1 is occupied by read. A measurement unit for the I/O is assumed to be within the latest unit time but may be set as a time duration from a certain time to the current time.

When I/O of the storage device 4 in the target application 321 is classified into sequential and random, a sequential ratio in the column 2323 is a proportion occupied by sequential. In the row 2327, a sequential ratio is 0.2, meaning that 20% of total I/O in the application AP1 is occupied by sequential. It is assumed in the illustrated example that a data length as a determination reference between the sequential and random is set at some fixed value, but may be set at a statistical average value or at a value statistically found.

A virtual volume capacity in the column 2324, when a data storage area (e.g., file system) is created to be used by the target application 321, is the size of a volume required from the viewpoint of long-term operation.

A data capacity in the column 2325 is the capacity of data actually written and stored in the virtual volume 45 for the time being after the operation of the target application 321 is stared. As specific examples shown in the row 2327, a file system of 10 TB is created as a virtual volume capacity, and the capacity of data (data capacity) written in the operation for the time being is 1 TB.

An application group in the column 2326 has an application group name as a result when the applications 321 are grouped on the basis of their I/O characteristics. The example shown in FIG. 6 corresponds to the structure of the application groups exemplified in FIG. 5.

### (Dynamic Allocation Pool Management Table)

FIG. 7 shows an exemplary structure of the dynamic allocation pool management table 233 stored in the operation management server. The dynamic allocation pool management table 233 is used to manage the state of the dynamic allocation pool 44 in the storage device 4.

The dynamic allocation pool management table 233 has a pool ID column 2331, an application group column 2332, a read ratio column 2333, a sequential ratio column 2334, a data capacity column 2335, a necessary capacity column 2336, a volume type column 2337, and in-pool volume capacity column 2338, respectively including the corresponding fields.

A pool ID in the column 2331 is information about the identifier of the dynamic allocation pool 44 in the storage device 4, and is used as a primary key in the dynamic allocation pool management table 233. An application group in the column 2332 is similar to the application group explained in FIGS. 5 and 6, and has a 1:1 relationship with the pool ID. It is assumed in FIG. 7 that the application group is provided as another column when the application group cannot keep temporarily a 1:1 relationship with pool ID for reconfiguration (to be explained later). However, the pool ID and the application group may be given in the same column by permitting temporary nonrelationship.

Read ratios in the column 2333, sequential ratios in the column 2334, data capacities in the column 2335, and necessary capacities in the column 2336 are derived from he application groups having the pool IDs and the characteristics of the applications 321 belonging to the application groups. The data capacity is a total value of capacities of data actually required by the application 321 belonging to the application group. Whereas, the necessary capacity is the capacity of the dynamic allocation pool necessary for the application and calculated on the basis of the data capacity.

The calculation of the necessary capacity is carried out by the dynamic allocation pool management unit 225 with use of an equation (1) which will be given later. The volume type in the column 2337 is the type of the real volume 431 used for configuring the dynamic allocation pool 44 having the pool ID. At the time point of creating the dynamic allocation pool 44, the volume type is “not set”. When the relationship of the volume type with the real volume 431 is determined, however, the volume type (for example, the type of such a RAID configuration as RAID1 or RAID5) is recorded. The in-pool volume capacity in the column 2338 is a total value of capacities of the real volumes 431 linked to the dynamic allocation pool 44 having the pool ID.

### (Real Volume Management Table)

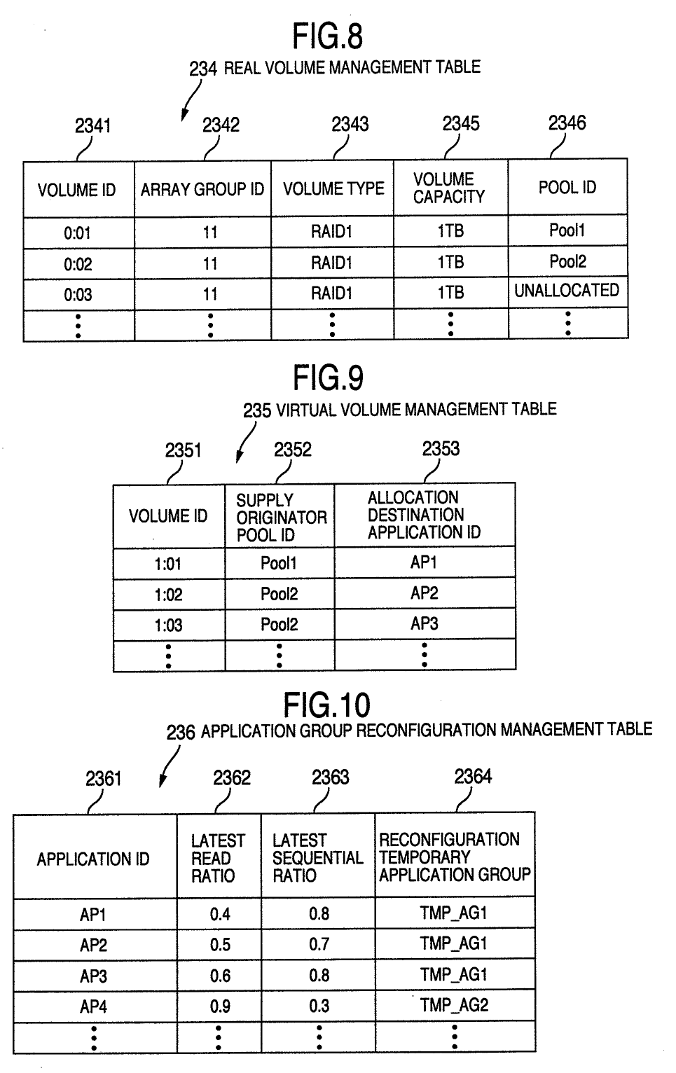

FIG. 8 shows an exemplary structure of the real volume management table 234 stored in the operation management server. The real volume management table 234 is used to manage the linkage state of the real volume 431 in the storage device 4 linked to the dynamic allocation pool 44.

The real volume management table 234 has a volume ID column 2341, an array group ID column 2342, a volume type column 2343, a volume capacity column 2345, and a pool ID column 2346, respectively including the corresponding fields.

A volume ID in the column 2341 is information about the identifier of the real volume 431 in the storage device 4, and used as a primary key in the real volume management table 234. When there are a plurality of the storage devices 4 in the storage operation management system 1, the volume ID has a format including the identifiers of the storage devices 4. However, the identifiers of the storage devices 4 may be provided in a separate column different from the volume ID column. An array group ID in the column 2342 is information about the identifier of the array group 43 in the storage device 4. A volume type in the column 2343 is the type of the real volume 43. As an example, such a type of RAID configuration as RAID1 or RAID5 is recorded in the column 2343. A volume capacity in the column 2345 is the capacity of the corresponding real volume 431. A pool ID in the column 2346 indicates the state of a linkage relationship of the corresponding real volume 431 to the dynamic allocation pool 44. Based on the pool ID, the real volume management table 234 is linked to the dynamic allocation pool management table 233 of FIG. 7. In this connection, in the case of no allocation to the dynamic allocation pool 44, “unallocated” is recorded in the pool ID column 2346.

It is assumed that information about all the real volumes 431 in the storage device 4 as a management target is previously acquired through the storage setting unit 421 and the storage management unit 223, and is stored by the real volume management unit 226 in the real volume management table 234.

### (Virtual Volume Management Table)

FIG. 9 shows an exemplary structure of the virtual volume management table 235 stored in the operation management server. The virtual volume management table 235 is used to manage the states of the virtual volumes 45 in the storage device 4.

The virtual volume management table 235 has a volume ID column 2351, a supply originator pool ID column 2352, and an allocation destination application ID column 2353, respectively including the corresponding fields.

A volume ID in the column 2351 is information about the identifier of the virtual volume 45 in the storage device 4, and used as a primary key in the virtual volume management table 235. When there are a plurality of the storage devices 4 in the storage operation management system 1, the volume ID has a format including the identifiers of the storage devices 4. However, the identifiers of the storage devices 4 may be provided in a separate column. A supply originator pool ID in the column 2352 indicates a correspondence with the dynamic allocation pool 44 having data about the virtual volume 45 actually stored therein, and a value corresponding to the pool ID of the dynamic allocation pool management table 233 is recorded in the column 2352. An allocation destination application ID in the column 2353 indicates the application 321 within the business server 3 using the corresponding virtual volume 45. For example, the value of the application ID column 2321 in the application management table 232 is recorded in the column 2353.

### (Application Group Reconfiguration Management Table)

FIG. 10 shows an exemplary structure of the application group reconfiguration management table 236 stored in the operation management server. The application group reconfiguration management table 236 is temporarily used in the reconfiguring operation when a new application 321 is added or when the I/O characteristic of the application 321 is changed.

The application group reconfiguration management table 236 has an application ID column 2361, a latest read ratio column 2362, a latest sequential ratio column 2363, and a reconfiguration temporary application group column 2364, respectively including the corresponding fields.

An application ID in the column 2361 is information about the identifier of the application 321, and is used as a primary key in the application group reconfiguration management table 236. A latest read ratio in the column 2362 is defined in the same manner as the read ratio in the application management table 232 of FIG. 6, and is a read ratio in the reconfiguration execution mode of the application 321. A latest sequential ratio in the column 2363 is defined in the same manner as the sequential ratio in the application management table 232 of FIG. 6, and is a sequential ratio in the reconfiguration execution mode of the application 321. A reconfiguration temporary application group in the column 2364 is derived from the latest read ratio and the latest sequential ratio, and indicates the configuration state of a desirable application group after the reconfiguration.

### (Application I/O Characteristic Table)

FIG. 11 shows an exemplary structure of the application I/O characteristic table 332 stored in the business server. The application I/O characteristic table 332 is used to manage the I/O state of the application 321 being operated in the business server 3 to the virtual volume 45.

The application I/O characteristic table 332 has a volume ID column 3321, an application ID column 3322, a read frequency column 3323, a write frequency column 3324, a sequential frequency column 3325, and a random frequency column 3326, respectively including the corresponding fields.

A volume ID in the column 3321 is information about the identifier of the virtual volume 45 in the storage device 4, and is used as a primary key in the application I/O characteristic table 332. An application ID in the column 3322 is information about the identifier of the application 321 being executed in the business server 3. A read frequency in the column 3322 indicates the number of read requests among accesses to the virtual volume 45 (which will be referred to as the virtual volume 45, hereinafter) having the volume ID from the application 321 (which will be referred to as the application 321, hereinafter) having the application ID. A write frequency in the column 3324 is the number of write requests among accesses from the application 321 to the virtual volume 45.

A sequential frequency in the column 3325 is the number of ones of accesses from the application 321 to the virtual volume 45 when a data length for one-time I/O is longer than a predetermined value. A read frequency is the number of ones of accesses from the application 321 to the virtual volume 45 when a data length for one-time I/O is shorter than the predetermined value. In this case, the data length as a determination reference between the sequential and random is assumed to be set at the predetermined fixed value. However, the data length may be set at a statistical average value or at a value statistically found. The measurement unit for the read frequency, write frequency, sequential frequency and random frequency is assumed to be within the latest unit time. However, the measurement unit may be set as a time duration from a certain time to the current time or as a frequency in a predetermined time period.

### (Application Throughput Table)

FIG. 12 shows an exemplary structure of the application throughput table 333 stored in the business server. The application throughput table 333 is used to manage the input/output state of the application 321 being operated in the business server 3 to the virtual volume 45.

The application throughput table 333 has a volume ID column 3331, an application ID column 3332 and a response time column 3333, respectively including the corresponding fields.

A volume ID in the column 3331 is information about the identifier of the virtual volume 45 in the storage device 4, and is used as a primary key in the application throughput table 333. An application ID in the column 3332 is information about the identifier of the application 321. A response time in the column 3333 is a response time of an access from the application 321 having the application ID to the virtual volume 45 having the volume ID. A measurement unit for the response time is assumed to be within the latest unit time. However, the measurement unit may be set at a time duration from a certain time to the current time or at a response time in a predetermined time period.

### (Requirement-Index-Added Application Management Table)

FIG. 13 shows an exemplary structure of a requirement-index-added application management table 232′ stored in the operation management server.

The requirement-index-added application management table 232′ is a table when a requirement index relating to the storage device 4 is added to the application management table 232 of FIG. 6. The requirement-index-added application management table 232′ is regarded as an alternate table to the application management table 232 of FIG. 6. In FIG. 13, constituent elements similar to those in FIG. 6 are denoted by the same reference numerals and explanation thereof is omitted.

A request response time in a request response time column 2328 is a response time of input/output from the application 321 having the application ID to the storage device 4. The request response time in the column 2328 is one of performance indexes necessary for attaining a throughput of the application 321 demanded in business. In the present embodiment, the response time is employed as the performance index. However, another performance index such as IOPS or a data transmission amount per unit time may be used as the performance index. A degree of reliability or cost may be used as a requirement index other than the performance index.

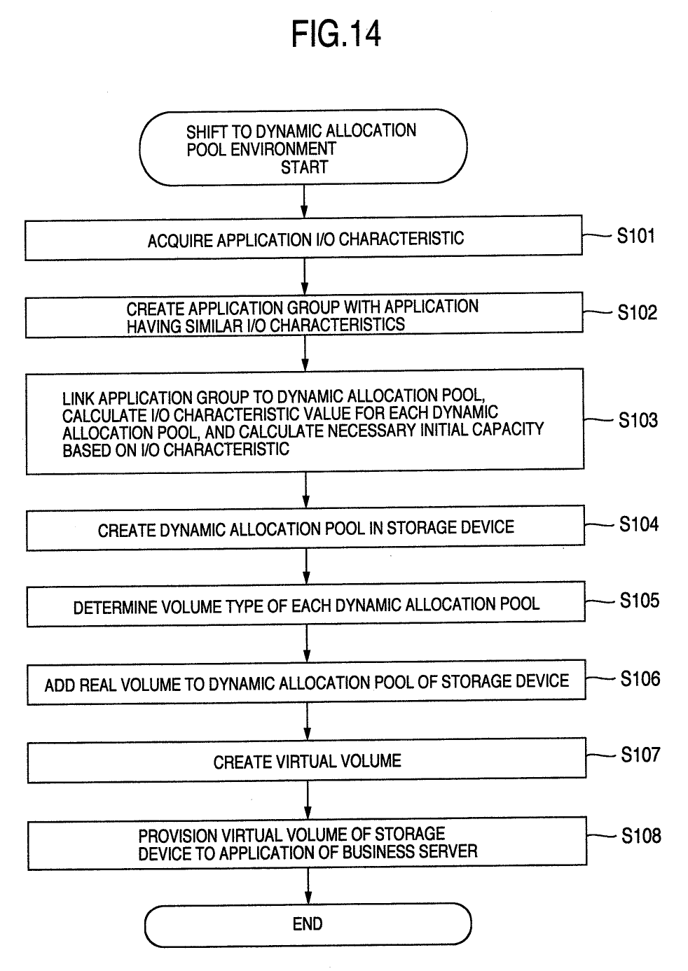

A flow of operations of storage operation management in the present embodiment will next be explained by referring to FIGS. 1 to 13 and in connection with FIGS. 14 to 17.

As details of processing operations of the present invention, the phases of five scenes, that is, (1) shift to the dynamic allocation pool 44 of the existing application 321 already installed, (2) addition of a new application 321 to the environment of the dynamic allocation pool 44 being operated, (3) reconfiguration of the application group based on a change in the I/O characteristic, (4) reconfiguration of the application group based on the requirement index, and (5) change of the volume type of the dynamic allocation pool 44 involved by real volume depletion, will be explained according to the application scene in storage operation management.

### (Shift of Existing Application to Dynamic Allocation Pool Environment)

FIG. 14 is a flow chart showing a flow of operations of shifting an existing application to a dynamic allocation pool environment in the present invention.

The I/O characteristics of the existing application 321 is previously known directly after introduction of the dynamic allocation pool 44, and the processing operation of FIG. 14 is carried out when the application 321 is shifted to the environment of the dynamic allocation pool 44.

When a storage management program is activated, the I/O information monitoring unit 322 of the business server 3 monitors the operation of the application 321 being executed in the business server 3. Under control of the I/O information monitoring unit 322, the acquired I/O characteristic of the application 321 and throughput information are stored in the application I/O characteristic table 332 and in the application throughput table 333.

The application management unit 224 of the operation management server 2 acquires I/O characteristics of the application 321 such as the application ID, read frequency, write frequency, sequential frequency and random frequency of the columns 3321 to 3326 from the application I/O characteristic table 332 under control of the business server 3 via the business server management unit 222 (step S101). The application ID, when the application 321 is installed in the business server 3, is issued by the business server 3. The application management unit 224 calculates a read ratio relating to the I/O characteristics on the basis of the acquired read and write frequencies, and also calculates a sequential ratio relating to the I/O characteristics on the basis of the sequential and random frequencies. The application management unit 224 records the application ID, the read ratio, and the sequential ratio in the corresponding fields of the columns 2321, 2322, and 2323 of the application management table 232. At this time, information on one application 321 is recorded in a single row of the application management table 232.

At this time, it is assumed that the system administrator enters the virtual volume capacity and the data capacity in the application management table 232 into the operation management server 2 with use of the operation management terminal 5 to cause the application management unit 224 to be stored in the application management table 232. However, the I/O information monitoring unit 322 of the business server 3 may acquire the virtual volume capacity and the data capacity from the application 321, transmit the acquired data to the operation management server 2, and input data to the application management unit 224 via the business server management unit 222 of the operation management server 2. At the time point of the step S101, no value is set in the application group column 2326 of the application management table 232. Or the system administrator may not use the I/O information monitoring unit 322, but may enter results of theoretical prediction of the I/O characteristics of the application 321 into the operation management server 2 to cause the application management unit 224 to store the theoretically-predicted results in the application management table 232.

After the step S101, the application management unit 224 refers to the read ratio column 2322 and the sequential ratio column 2323 in the application management table 232, and creates an application group on the basis of a degree of similarity between I/O characteristics calculated based on the read and sequential ratios (step S102). As an example of a method of calculating the degree of similarity, it is considered to create an application group in such a manner that the applications 321 having a distance therebetween not larger than a specified value in a coordinate system having two axes of read and sequential ratios are set to belong to the same group. For example, when 0.3 is employed as the specified value and the distance is calculated from the read and sequential ratios for the applications AP1 to AP4, only a distance between the applications AP2 and AP3 is within the specified value. As a result, the applications AP2 and AP3 are grouped as the same application group. Such a conception is shown in FIG. 5 in a model form. A result of the grouping is recorded in the application group column 2326 of the application management table 232.

After the step S102, a step S103 is executed. In the step S103, the dynamic allocation pool management unit 225 links the application group to the dynamic allocation pool 44 in a 1:1 relationship by associating the application group of the application management table 232 with the pool ID of the dynamic allocation pool 44 issued from the storage device 4 and by recording the associated data in the pool ID column 2331 and the application group column 2332 in the dynamic allocation pool management table 233 (step S103). In the step S103, the dynamic allocation pool management unit 225 then calculates an average value of read and sequential ratios (I/O characteristics) of the applications 321 belonging to the linked application group by referring to the application management table 232 (step S103). That is, the dynamic allocation pool management unit 225 calculates the I/O characteristic values for each dynamic allocation pool. The average calculation may be carried out as a simple average or as a weighted average based on capacity. In the step S103, further, the dynamic allocation pool management unit 225 calculates a total value of data capacities required by the applications 321 included in the application group associated for each dynamic allocation group, and records the calculated value in the data capacity column 2335 of the dynamic allocation pool management table 233 as the data capacity of the dynamic allocation pool 44.

The dynamic allocation pool management unit 225 further calculates a capacity of the real volume 431 required to be stored in the dynamic allocation pool 44 as the initial capacity of the dynamic allocation pool 44 on the basis of the sequential ratios and the data capacities in the application management table 232. That is, the dynamic allocation pool management unit 225 calculates the initial capacity (necessary capacity) of the necessary dynamic allocation pool 44 on the basis of the I/O characteristics (step S103). An example of an equation for calculating the initial capacity (necessary capacity) using a coefficient is shown below as an equation (1). In this case, the calculation has been expressed as the equation, but such a table as to define a relationship between the sequential ratio and the necessary capacity may be prepared as necessary.

Necessary capacity=min{virtual volume capacity, data capacity/(k+sequential ratio×(1−k))} (1)

,wherein 0<k<1

The value of k, even when fixed in the storage management system, may be set for each of the applications 321 or for each of the types of the applications 321 by the system administrator Or the k value may be set for each of the applications 321 or for each of the types of the applications 321 on the basis of the storage capacity actually allocated to the virtual volume 45 from the dynamic allocation pool 44 and of the actual data capacity of the application 321.

The dynamic allocation pool management unit 225 records the calculated necessary initial capacity in the necessary capacity column 2336 of the dynamic allocation pool management table 233.

After the step S103, the storage management unit 223 refers to the dynamic allocation pool management table 233 and calls the storage setting unit 421 of the storage device 4 for managing the corresponding pool ID. Whereas, the called storage setting unit 421 creates, in the storage device 4, the dynamic allocation pool 44 confirming to the settings stored in the dynamic allocation pool management table 233 (step S104).

After completion the processing operation of the step S104, the dynamic allocation pool management unit 225 refers to the dynamic allocation pool management table 233 and the previously-recorded real volume management table 234, and determines the volume type of each dynamic allocation pool 44 on the basis of the capacities of all the real volumes 431 in the storage management system, application group relative positions in the two axis system of the read and sequential ratios, the necessary capacities, etc. (step S105). In this connection, it is assumed that, with respect to the real volume management table 234, information about all the real volumes 431 in the storage device 4 are previously acquired via the storage setting unit 421 of the storage device 4 and via the storage management unit 223 of the operation management server 2, and are previously recorded in the real volume management table 234 under control of the real volume management unit 226.

As an example of a method of determining the volume type, it is considered to allocate RAID1 to the dynamic allocation pool 44 of the application group oriented to write (that is, having low read ratios) and to allocate RAID5 to the dynamic allocation pool 44 of the application group oriented to read (that is, having high read ratios). Based on this method, it is considered to prioritize the dynamic allocation pools 44 in the entire distribution of the volume types, arrange the order of the dynamic allocation pools 44 based on the method in the entire volume configuration, and determine the volume type of the dynamic allocation pool 44 based on such a method that one dynamic allocation pool 44 includes an identical type of the real volumes 431.

The dynamic allocation pool management unit 225 reflects the determined volume type on the volume type column 2337 of the dynamic allocation pool management table 233.

After the step S105, the real volume management unit 226 then refers to the dynamic allocation pool management table 233 and searches for the dynamic allocation pools 44 having pool IDs of in-pool volume capacities smaller than the necessary capacity. The storage management unit 223 calls the storage setting unit 421 in the storage device 4 and adds the real volume 431 to the searched dynamic allocation pools 44 (step S106). The real volume 431 as an addition target is set to have “unallocated” in the pool ID column 2346 of the real volume management table 234. In order to avoid access competition in the physical disk, the real volume management unit 226 distributes the real volumes in such a manner that the real volumes 431 having the same array group ID are not added to a plurality of the dynamic allocation pools 44 in the real volume management table 234.

The virtual volume management unit 227 transmits data recorded in the application management table 232 and in the dynamic allocation pool management table 233 to the storage device 4 via the storage management unit 223. Whereas, the storage setting unit 421 of the storage device 4 creates the virtual volume 45 required by the application 321 on the basis of the received data (step S107). After the processing operation of the step S107, the storage setting unit 421 transmits data (volume ID, supply originator pool ID, etc.) relating to the created virtual volume 45 to the operation management server 2. Whereas, the virtual volume management unit 227 of the operation management server 2 records the received data in the virtual volume management table 235.

When the virtual volume 45 created in the step S107 is linked to the port 46, the storage setting unit 421 can be accessed by the application 321. In other words, the storage setting unit 421 causes the virtual volume 45 of the storage device 4 to be provisioned to the application 321 of the business server 3 (step S108). When acquiring an ID (application ID of an allocation destination) of the application 321 which became accessible in the step S108, the storage setting unit 421 transmits the acquired ID to the operation management server 2. The virtual volume management unit 227 of the operation management server 2 records the received allocation destination application ID in the allocation destination application ID column 2353 of the virtual volume management table 235.

(Addition of New Application to Dynamic Allocation Pool Environment being Operated)

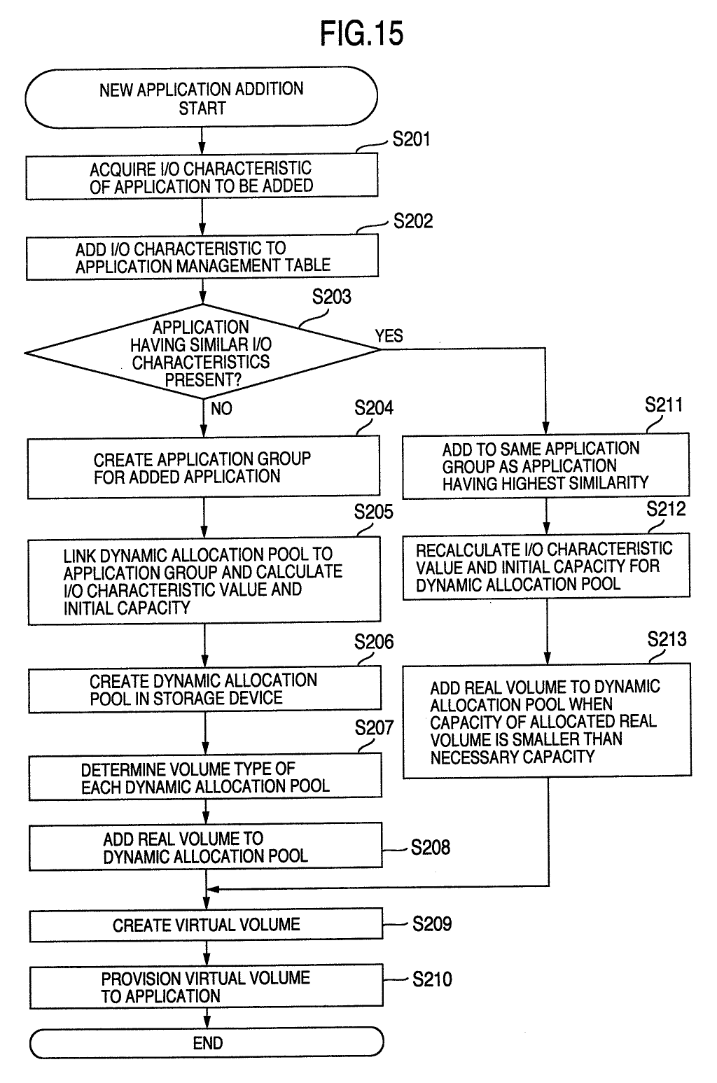

FIG. 15 is a flow chart showing a flow of operations of adding a new application to a dynamic allocation pool environment being operated in the present embodiment.

Under a condition that the storage management program is activated, the I/O information monitoring unit 322 of the business server 3 monitors the operation of the application 321 being executed in the business server 3. The I/O information monitoring unit 322 records the I/O characteristics and throughput information of the acquired application 321 in the application I/O characteristic table 332 and in the application throughput table 333.

The application management unit 224 of the operation management server 2 performs operation similar to the step S101 of FIG. 14 and acquires the I/O characteristics of the addition target application 321 (step S201), and adds the I/O characteristic information (application ID, read ratio, sequential ratio) of the addition target application 321 in the application ID column 2321, read ratio column 2322, and sequential ratio column 2323 of the application management table 232 (step S202).

Next, the application management unit 224 compares a row added in the application management table 232 in the step S202 with a row already recorded in the application management table 232 prior to the step S202 to know a degree of similarity between the I/O characteristics, and determines the presence or absence of the existing application 321 with a distance from the added application 321 not larger than a specified value. That is, the application management unit 224 determines the presence or absence of the application 321 having I/O characteristics similar to the added application (step S203). The comparison in similarity between the I/O characteristics is carried out in the same manner as the processing operation of the step S102 of FIG. 14.

When the application 321 having the similar I/O characteristics is absent in the step S203 (S203→No), the application management unit 224 performs the operations of steps S204 to S210. That is, the application management unit 224 creates a new application group for the added application 321 and allocates the dynamic allocation pool 44 to the created application group. The operations of the steps S204 to S210 are similar to those of the steps S102 to S108 in FIG. 14, except that the processing target is the added application 321, and thus explanation thereof is omitted.

When determining the presence of the application 321 having similar I/O characteristics in the step S203 (S203→Yes), the application management unit 224 refers to the row added in the step S202 and a row having the highest similarity in I/O characteristics (the added application 321 and the application 321 having the highest similarity in I/O characteristics) among existing rows of the application management table 232, and reflects the application group of the rows upon the application group column 2326 of the row added in the step S202. That is, the application management unit 224 adds the added application 321 to the same application group as the existing application 321 having the highest similarity (step S211).

After the step S211, the dynamic allocation pool management unit 225 performs operation similar to the step S103 of FIG. 14 over the dynamic allocation pool 44 corresponding to the application group as a target in the step S211 to recalculate I/O characteristic values and a necessary capacity (step S212).

When the virtual volume management unit 227 compares the necessary capacity reset in the step S212 with the in-pool volume capacity and the in-pool volume capacity is smaller than the necessary capacity, the virtual volume management unit 227 performs operation similar to the step S106 to link the real volume 431 to the dynamic allocation pool 44. When a total value of the capacities of the already-allocated real volumes 431 is smaller than the necessary capacity, the virtual volume management unit 227 adds the real volume 431 to the target dynamic allocation pool 44 (step S213).

After the operation of the step S213, the storage device 4 performs the operations of the steps S209 and S210.

When the I/O characteristics of the added application 321 are unknown, input of the I/O characteristics of the added application 321 theoretically calculated by the system administrator and input of the added application 321 to the existing application group may, in some cases, result in the fact that the actual I/O characteristics of the added application 321 are deviated from the theoretically-calculated I/O characteristics. That is, there is a case where the I/O characteristics of the application 321 recognized by the system administrator are different from the actual I/O characteristics. In such a case, access competition to physical disk may cause reduction of a throughput.

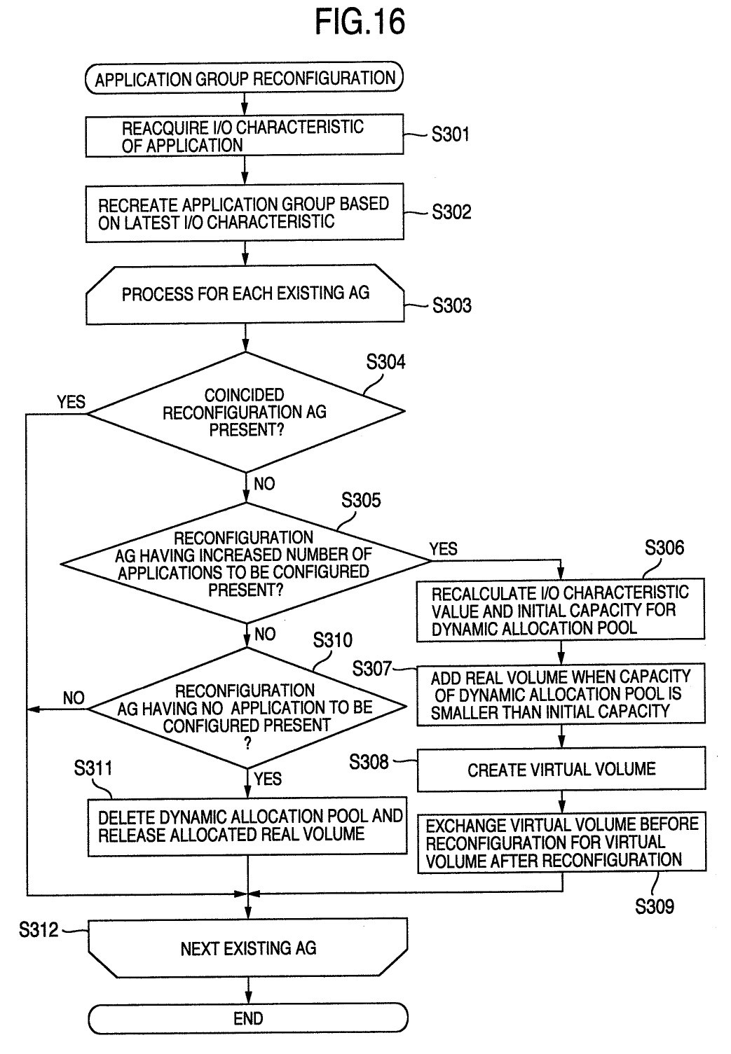

In order to avoid such a situation, the I/O characteristic values of the added application 321 may be treated as unknown, a new application group independent of the existing application groups may be created, and the new dynamic allocation pool 44 may be allocated to the new created application group. In this case, when actual I/O characteristics of the added application 321 are acquired in the I/O information monitoring unit 322 of the business server 3, application groups (to be explained later in FIG. 16) is reconfigured so that the suitable application group and dynamic allocation pool 44 can be utilized.

### (Application Group Reconfiguration Based on Change in I/O Characteristics)

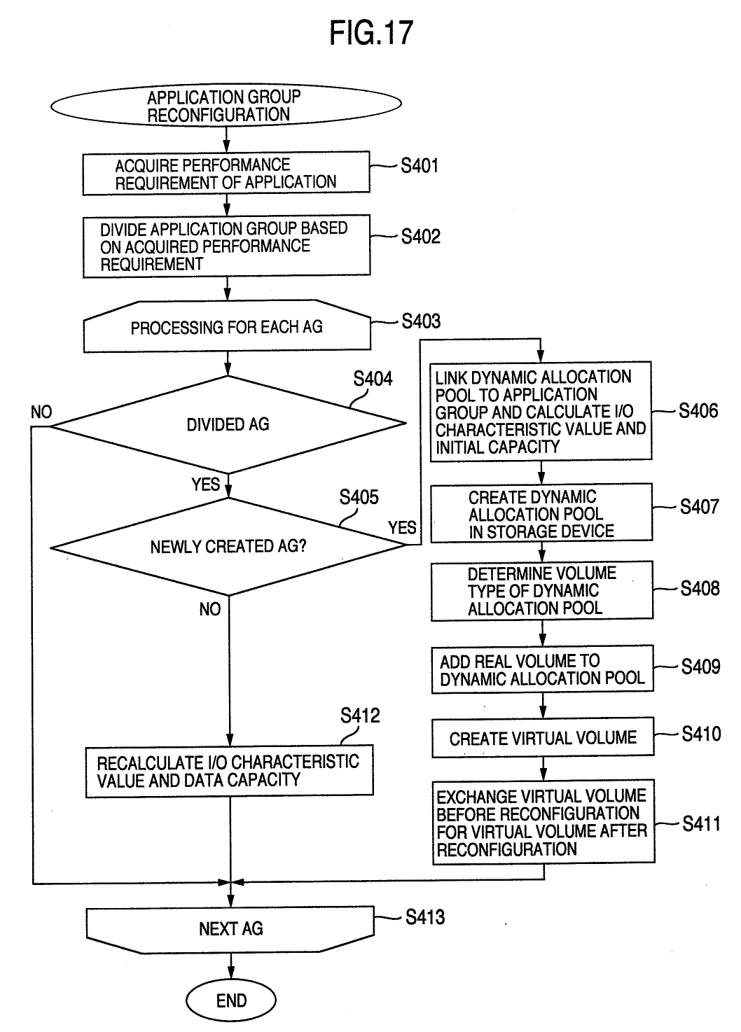

FIG. 16 is a flow chart showing a flow of operations of reconfiguring application groups based on a change in I/O characteristics in the present embodiment. In FIGS. 16 and 17, an application group is denoted by AG as necessary.

When the operation of the application in the dynamic allocation pool 44 is started and thereafter I/O characteristics of the application 321 being operated is changed, the processing operations of FIG. 16 are carried out to reconfigure the application groups and dynamic allocation pools 44 for the purpose of avoiding reduction of a throughput caused by access competition of the physical disk. The processing operations of FIG. 16 are carried out by the operation management server 2 which monitors the I/O characteristics of the application 321, for example, at periods of once per week or at all times and which displays the values of the I/O characteristics on a display unit (not shown) of the operation management terminal 5 via the network 6, and by the administrator who sends an instruction to the operation management server 2 to execute the processing operations of FIG. 16 on the basis of the displayed values.

Under a condition that the storage management program is activated, the I/O information monitoring unit 322 of the business server 3 monitors the operation of the application 321 being operated, the application management unit 224 of the operation management server 2 again acquires the I/O characteristics of the application 321 from the business server 3 via the business server management unit 222 (step S301), and records the reacquired latest I/O characteristic information (application ID, latest read ratio, and latest sequential ratio) in the application ID column 2361, latest read ratio column 2362 and latest sequential ratio column 2363 of the application group reconfiguration management table 236. The operation of the step S301 is similar to the operation of the step S101 in FIG. 14 or to the operation of the step S201 in FIG. 15, and thus detailed explanation thereof is omitted.

In a step S302, the application management unit 224 calculates a degree of similarity between the I/O characteristics, reconfigures the application groups by performing operation similar to the step S102 of FIG. 14 on the basis of the latest I/O characteristics (latest read ratio, latest sequential ratio) of the application group reconfiguration management table 236 (step S302), and records the reconfigured application groups in the reconfiguration temporary application group column 2364 of the application group reconfiguration management table 236.

Steps S304 to S311 are executed for each of the application groups (which will be referred to as the existing application groups, hereinafter) of the application management table 232. the application group in the application group reconfiguration management table 236 is referred to as the reconfiguration application group, hereinafter.

The application management unit 224 first determines the presence or absence of the existing application group as a target which coincides in application configuration with the reconfiguration application group (AG) (step S304).

In the presence of the coincided reconfiguration application group in the step S304 (S304→Yes), reconfiguration becomes unnecessary. Thus, the storage operation management unit 221 proceeds to a step S312 and repeats the operations of the steps S304 to S311 over the next existing application group.

In the absence of the reconfiguration application group coincided in the step S304 (S304→No), the application management unit 224 determines the presence or absence of the reconfiguration application group (AG) increased in the number of applications to be configured (step S305).

More specifically, the application management unit 224 refers to the application management table 232 and the application group reconfiguration management table 236, and determines the presence or absence of a reconfiguration application group which includes the application 321 belonging to the existing application group and also which includes a different application 321.

In the presence of the reconfiguration application group (AG) increased in the number of the applications 321 to be configured (S305→Yes), the operation management server 2 and the storage device 4 perform the operations of the steps S306 to S309 over the target reconfiguration application group. The operations of the steps S306 to S309 are similar to those of the steps S212, S213 and S209, 210 in FIG. 15. In the step S309, however, the storage setting unit 421 exchanges the virtual volume 45 in such a manner that data of the application 321 so far stored in the virtual volume 45 prior to the reconfiguration of the application groups can be accessed as it is after the reconfiguration. More specifically, after the storage setting unit 421 copies data about the virtual volume 45 prior to the reconfiguration of the application groups to the virtual volume 45 created in the step S308 upon the reconfiguration, the storage setting unit 421 provisions the virtual volume 45 created in the step S308 to the application 321 by utilizing the same provisioned format as the virtual volume 45 prior to the reconfiguration, and releases the virtual volume 45 prior to the reconfiguration. The storage setting unit 421 further updates the corresponding application group column 2326 of the application management table 232 associated with the different application 321 to the existing application group name.

In the absence of the reconfiguration application group increased in the number of the application 321 to be configured in the step S305 (S305→No), the application management unit 224 refers to the application group reconfiguration management table 236 and determines the presence or absence of the reconfiguration application group having no application 321 to be configured (step S310). After the operation of the step S310 is once carried out, the operation of the next loop may be omitted.

In the absence of the reconfiguration application group having no application 321 to be configured in the step S310, that is, when one or more applications become depleted from the existing application group and one or more applications remain in the existing application group (S310→No), the storage operation management unit 221 proceeds to the step S312 and repeats the operations of the steps S304 to S311. When one application group is divided into two or more application groups as a result of the reconfiguration, for example, in the step S310; with respect to any one of the application groups, the storage operation management unit 221 remains the corresponding application group column 2326 of the application management table 232 for the application 321 as it is, and with respect to the other application groups, the storage operation management unit 221 sets a new application group name for the corresponding application group column 2326 of the application management table 232.

In the presence of the reconfiguration application group having no application 321 to be configured in the step S310 (S310→Yes), the associated application group and the corresponding dynamic allocation pool 44 become unnecessary. Thus the storage management unit 223 causes the storage setting unit 421 of the storage device 4 to release the corresponding dynamic allocation pool 44 and the associated real volume 431 (step S311). The storage operation management unit 221 proceeds to the step S312 and repeats the operations of the steps S304 to S311 for the next existing application group. After completing the operations of FIG. 16 with regard to all the existing application groups, the application management unit 224 erases associated rows in the application group reconfiguration management table 236.

### (Application Group Reconfiguration Based on Requirement Index)

FIG. 17 is a flow chart showing a flow of operations of reconfiguring application groups based on requirement index in the present embodiment.

FIG. 17 shows another example of the application group reconfiguration shown in FIG. 16, when the application group reconfiguration is carried out based not on I/O characteristic but on performance requirement. The operation of FIG. 17 may be executed after the operation of FIG. 16 is completed or independently of the operation of FIG. 16. When the requirement indexes include such a request response time as shown by reference 2328 in FIG. 13, an IOPS and a data transmission amount per unit time; the operation of FIG. 17 may be executed by the operation management server 2 which monitors these requirement indexes in the application 321 and displays the acquired requirement indexes on the display unit (not shown) of the operation management terminal 5, and by the administer who transmits an instruction to the operation management server 2 to execute the operation of FIG. 17 on the basis of the displayed requirement indexes. The operation management server 2 monitors whether or not the requirement index of the application 321 in the application group is deviated by an amount of a predetermined value or more. When the requirement index is deviated by the predetermined value or more, the operation management server 2 may be allowed to start the operation of FIG. 17.

When the requirement index is a degree of reliability or cost, the administrator may transmit an instruction via the operation management terminal 5 to the operation management server 2 to execute the operation of FIG. 17, considering the requirement index.

Under conditions that the I/O characteristics of the application 321 are similar, but a high load of the application 321 belongs to the same application group, and the same dynamic allocation pool 44 is used; there is a case where access concentration to the same physical disk may cause the requirement index of the application 321 not to be satisfied. As the requirement indexes, the performances (IOPS, data transmission amount per unit time, response time) and indexes such as (degrees of) reliability and cost of the application 321 are considered, and division of expected and actually-measured values thereof is considered. An example of reconfiguration based on the division of the application group in such a case, is shown in FIG. 17. Although the actually measured value of the response time is employed as the requirement index, the other index or a combination of a plurality of indexes may be used.

The requirement index is acquired from the application 321 via the I/O information monitoring unit 322 of the business server 3 or the system administrator enters the requirement index from the operation management terminal 5, and the requirement index is recorded in the request response time column of the application management table 232.

The application management unit 224 of the operation management server 2 acquires the current throughput (the actually measured value of the response time in this case) from the application throughput table 333 of the business server 3 via the business server management unit 222 periodically or according to an as-necessary request via the operation management terminal 5 from the system administrator. That is, the application management unit 224 acquires the performance requirement of the application 321 from the business server 3 (step S401).

The application management unit 224 divides the application group according to the acquired performance requirement (step S402). More concretely, the application management unit 224 compares the acquired response time (performance requirement) with the request response time of the requirement-index-added application management table 232′. When the request response time exceeds the response time, this means that the performance index is not attained. The application management unit 224 divides the application group including the application 321 having the not-attained performance requirement and creates another application group including one or more of the applications 321 of the application group before divided. The application management unit 224 then records the name of the created application group in the application group column 2326 of the application management table 232 for the corresponding application 321.

As an example of the division method, it is considered to create an independent application group and to include one of the applications of the application group having the smallest request response time in the independent application group. However, another method may be used to include the application 321 in an independent application group. As another division method, it is also considered, when the request response time exceeds the response time, to independently create another application group including only the application 321 having the not-attained performance index.

Since the requirement index of some application 321 is considered to vary with a time zone, further, the request response time of the requirement-index-added application management table 232′ may be divided according to the time zone and the divided request response time may be recorded in the table. Even the I/O characteristic may be divided according to the time zone and may be used as a determination criterion when the application 321 is grouped.

Steps S404 to S412 show the processing operations to be carried out for each of the application groups of the application management table 232.

The application management unit 224 first determines whether or not a target application group is one of the divided application groups in the step S402 (step S404).

When the application management unit 224 determines in the step S404 that the target application group is not the divided application group (S404→No), no processing is required. Thus the storage operation management unit 221 proceeds to the step S413 and repeats the processing operations of the steps S404 to S412 for the next application group.

When the application management unit 224 determines in the step S404 that the target application group is the divided application group (S404→Yes), the application management unit 224 determines whether or not the target application group is a newly created application group (step S405).

When the application management unit 224 determines in the step S405 that the target application group is not the newly created application group (S405→No), the application management unit 224 again calculates the I/O characteristic value and the data capacity in a manner similar to the step S103 of FIG. 14, and updates the read ratio 2332, sequential ratio 2333 and data capacity 2335 in a row of the dynamic allocation pool management table 233 corresponding to the dynamic allocation pool 44 of the application group in question.

When the application management unit 224 determines in the step S405 that the target application group is the newly created application group (S405→Yes), the application management unit 224 executes the processing operations of the steps S406 to S411. The processing operations of the steps S406 to S410 are similar to those of the steps S205 to S209 of FIG. 15. The processing operation of the step S411 is similar to that of FIG. 16.

### (Change of Volume Type of Dynamic Allocation Pool 44 Caused by Real Volume Depletion)

After initial creation of the dynamic allocation pool 44, expansion of the capacity of the virtual volume 45 or increase of the data capacity of the application 321 is considered to cause the necessary capacity of the dynamic allocation pool 44 to gradually increase, with the result that the real volumes 431 addable to the volume types of the dynamic allocation pools 44 are eventually depleted.

In such a case, the depletion of the real volumes 431 can be avoided by the storage setting unit 421 of the storage device 4 which selects an arbitrary application group and its corresponding dynamic allocation pool and which exchanges all the real volumes 431 linked to the corresponding dynamic allocation pool for the real volumes 431 of another volume type having a sufficient capacity.

### (Effects)

In accordance with the present embodiment, an application group of applications having similar I/O characteristics is created, and the dynamic allocation pool 44 is allocated to the created application group. As a result, the applications 321 having the similar I/O characteristics are kept to have an access state to a physical disk having data within the dynamic allocation pool 44, throughput reduction caused by access competition of the applications having different I/O characteristics upon the disk access can be avoided, and the performance of the storage device 4 can be effectively exhibited.

In accordance with the present embodiment, further, since the necessary initial capacity of the dynamic allocation pool 44 is calculated from the real data capacity of the application 321 on the basis of the I/O characteristics, the dynamic allocation pool 44 can be easily designed.

In the present embodiment, the dynamic allocation pool 44 is operated so as to satisfy the requirements of the application 321 including performance, reliability and security. As a result, the performance of the storage device 4 can be effectively exhibited.

In the present embodiment, the application groups are reconfigured according to a change in the I/O characteristics caused by the operation of the application 321, and the dynamic allocation pool 44 is allocated to the reconfigured application group. As a result, the requirements of the application 321 can be continuously satisfied during the operation of the application 321 advantageously.

It should be further understood by those skilled in the art that although the foregoing description has been made on embodiments of the invention, the invention is not limited thereto and various changes and modifications may be made without departing from the spirit of the invention and the scope of the appended claims.

1. A storage management method in a storage management apparatus for determining a dynamic allocation pool managing allocation of a real volume of a storage device to a virtual volume,
wherein the storage management apparatus acquires an I/O characteristic of an application being executed in an application execution device, stores I/O characteristic information linked between the application and the I/O characteristic of the application in a memory for the each application, calculates a degree of similarity between the I/O characteristics of the applications on the basis of the I/O characteristic of the memory, groups the application into a plurality of groups according to the degree of similarity, and links the group to the dynamic allocation pool.

2. The storage management method according to claim 1, wherein the I/O characteristic and a capacity of data to be actually used by the application in the virtual volume are linked to each other and recorded, and the storage management apparatus calculates a capacity of the dynamic allocation pool necessary for the application on the basis of the I/O characteristic in the memory and the capacity of the data to be used by the application and sets the calculated capacity as an initial capacity of the dynamic allocation pool.

3. The storage management method according to claim 1, wherein a performance requirement showing a performance of the application is stored in the memory for the each application, and the storage management apparatus again groups the application on the basis of the performance requirement.

4. The storage management method according to claim 1, wherein the storage management apparatus allocates a volume type indicative of a type of a volume to the dynamic allocation pool.

5. The storage management method according to claim 1, wherein the I/O characteristic is a ratio in a method of access of the application to the storage device.

6. The storage management method according to claim 1, wherein the performance requirement is a response time of the application to the storage device.

7. The storage management method according to claim 1, wherein the performance requirement is a degree of reliability to the application.

8. The storage management method according to claim 1, wherein the storage management apparatus newly acquires an I/O characteristic and again groups of the application on the basis of the newly acquired I/O characteristic.

9. The storage management method according to claim 8, wherein, when a group having the application not allocated thereto is present as a result of the regrouping, the storage management apparatus releases the dynamic allocation pool so far allocated to the group and releases the real volume so far allocated to the dynamic allocation pool.

10. The storage management method according to claim 2, wherein the storage management apparatus newly acquires the I/O characteristic, regroups the application on the basis of the newly-acquired I/O characteristic, and recalculates an initial capacity of the dynamic allocation pool when a group having the allocated applications increased as a result of the regrouping is present.

11. The storage management method according to claim 5, wherein the access method includes a random access and a sequential access.

12. The storage management method according to claim 5, wherein the access method includes a write to the storage device and a read from the storage device.

13. The storage management method according to claim 1, wherein, when a new application to be accessed to the storage device is added, the storage management apparatus acquires an I/O characteristic of the newly-added application via an input unit or a communication unit, and when a group present within a predetermined distance from the I/O characteristic of the added application is present, adds the added application to the group.

14. The storage management method according to claim 13, wherein, when a group present within a predetermined distance from the I/O characteristic of the added application is not present, the storage management apparatus creates a new group for the added application and determines the allocation of the dynamic allocation pool on the basis of the new group.

15. The storage management method according to claim 4, wherein, when the capacity of the real volume necessary in the dynamic allocation pool is increased and the capacity of the real volume becomes insufficient, the storage management apparatus exchanges the real volume being connected for the real volume of a volume type having a spare capacity larger than the connected real volume.

16. A storage management program for causing a computer to implement the storage management method set forth in any one of claims 1 to 14.

17. A storage management apparatus for determining a dynamic allocation pool managing allocation of a real volume in a storage device to a virtual volume, comprising:
an application characteristic acquiring unit for acquiring an I/O characteristic of an application being executed in an application execution device;
an application management unit for storing I/O characteristic information indicative of a linkage between the application and an I/O characteristic of the application in a memory for the each application, calculating a degree of similarity between the I/O characteristics of the applications on the basis of the I/O characteristic of the memory, and grouping the application into a plurality of groups according to the degree of similarity; and
a dynamic allocation pool management unit for linking the group to the dynamic allocation pool.

18. The storage management apparatus according to claim 17, wherein the I/O characteristic and a capacity of data to be actually used by the application in the virtual volume are linked to each other and stored in the memory, and the dynamic allocation pool management unit also has a function of calculating a capacity of the dynamic allocation pool necessary for the application on the basis of the I/O characteristic of the memory and the capacity of data to be used in the application, and setting the calculated capacity as an initial capacity of the dynamic allocation pool.

19. A storage management system comprising:
a storage device;
a storage management apparatus for determining a dynamic allocation pool managing allocation of a real volume in the storage device to a virtual volume; and
an application execution device for executing an application,
wherein the storage device, the storage management apparatus, and the application execution device being interconnected each other,
the storage management apparatus includes:
an application characteristic acquiring unit for acquiring an I/O characteristic of the application being executed in the application execution device;
an application management unit for storing I/O characteristic information indicative of a linkage between the application and the I/O characteristic of the application in a memory for the each application, calculating a degree of similarity between the I/O characteristics of the applications on the basis of the I/O characteristic of the memory, and grouping the application into a plurality of groups according to the degree of similarity; and
a dynamic allocation pool management unit for linking the group to the dynamic allocation pool.
